(19) United States
(12) Patent Application Publication
(10) Pub. No.: US 2010/0061776 A1
(43) Pub. Date: Mar. 11, 2010

(54) DEVELOPER AND IMAGE FORMING APPARATUS

(76) Inventor: Takeshi KOJIMA, Tokyo (JP)

Correspondence Address: Kubotera & Associates, LLC, 200 Daingerfield Rd, Suite 202, Alexandria, VA, 22314, US

(21) Appl. No.: 12/544,587

(22) Filed: Aug. 20, 2009

(30) Foreign Application Priority Data
Sep. 5, 2008 (JP) 2008-227859

(51) Int. Cl. G03G 15/08

(52) U.S. Cl. 399/285

(57) ABSTRACT

Developer is to be used in an image forming apparatus of an electro-photography type, in which a developer supporting member attaches the developer to a static latent image supporting member for developing a static latent image. The developer includes an outer additive; and base particles. Further, the developer has a charge amount Q1 before the image forming apparatus performs a continuous printing operation and a charge amount Q2 after the image forming apparatus performs the continuous printing operation so that a ratio of Q1 to Q2 (Q1/Q2) becomes between 0.81 and 0.94.

### BACKGROUND OF THE INVENTION AND RELATED ART STATEMENT

The present invention relates to developer used in an image forming apparatus of an electro-photography type such as a printer, a facsimile, a copier, and the likes for developing a static latent image.

In a conventional image forming apparatus of an electro-photography type such as a facsimile, a copier, and the likes, a developing roller as a developer supporting member attaches developer to a photosensitive drum as a static latent image supporting member for developing a static latent image. In the process, when the conventional image forming apparatus of the electro-photography type uses non-magnetic one component developer, it is important to maintain good charging property of toner as developer for obtaining good image quality.

Patent Reference has disclosed a technology in which an absolute value of a charge amount of toner is maintained above 3.4 μC/g, thereby obtaining a good toner image.

Patent Reference: Japanese Patent Publication No. 08-334955

In the technology disclosed in Patent Reference, when the conventional image forming apparatus performs a continuous printing operation using toner, image quality tends to lower.

In view of the problems described above, an object of the present invention is to provide developer having an optimal charge amount, thereby improving image quality.

Further objects and advantages of the invention will be apparent from the following description of the invention.

### SUMMARY OF THE INVENTION

In order to attain the objects described above, according to a first aspect of the present invention, developer is to be used in an image forming apparatus of an electro-photography type, in which a developer supporting member attaches the developer to a static latent image supporting member for developing a static latent image. The developer includes an outer additive; and base particles.

In the first aspect of the present invention, the developer has a charge amount Q1 before the image forming apparatus performs a continuous printing operation and a charge amount Q2 after the image forming apparatus performs the continuous printing operation so that a ratio of Q1 to Q2 (Q1/Q2) becomes between 0.81 and 0.94.

According to a second aspect of the present invention, developer is to be used in an image forming apparatus of an electro-photography type, in which a developer supporting member attaches the developer to a static latent image supporting member for developing a static latent image.

In the second aspect of the present invention, the developer includes an outer additive; and base particles having a charge amount Q0 before the outer additive is added thereto. Further, the developer has a charge amount Q1 after the outer additive is added to the base particles so that a ratio of Q0 to Q1 (Q0/Q1) becomes between 1.06 and 1.08.

In the present invention, it is possible to provide the developer having an optimal charge amount, thereby improving image quality.

### BRIEF DESCRIPTION OF THE DRAWINGS

FIG. 1 is a schematic view showing an image forming apparatus according to a first embodiment of the present invention;

FIG. 2 is a schematic view showing a photosensitive drum of the image forming apparatus according to the first embodiment of the present invention;

FIGS. 3(a) to 3(d) are schematic views showing samples of printed sheets according to the first embodiment of the present invention;

FIGS. 4(a) to 4(d) are tables showing evaluation results No. 1 of toner according to the first embodiment of the present invention;

FIG. 5 is a table showing evaluation results No. 2 of toner according to the first embodiment of the present invention;

FIG. 6 is a table showing evaluation results No. 3 of toner according to the first embodiment of the present invention;

FIG. 7 is a table showing evaluation results No. 1 of toner according to a second embodiment of the present invention;

FIG. 8 is a table showing evaluation results No. 2 of toner according to the second embodiment of the present invention; and

FIG. 9 is a table showing evaluation results No. 3 of toner according to the second embodiment of the present invention.

### DETAILED DESCRIPTION OF PREFERRED EMBODIMENTS

Hereunder, embodiments of the present invention will be explained with reference to the accompanying drawings.

### First Embodiment

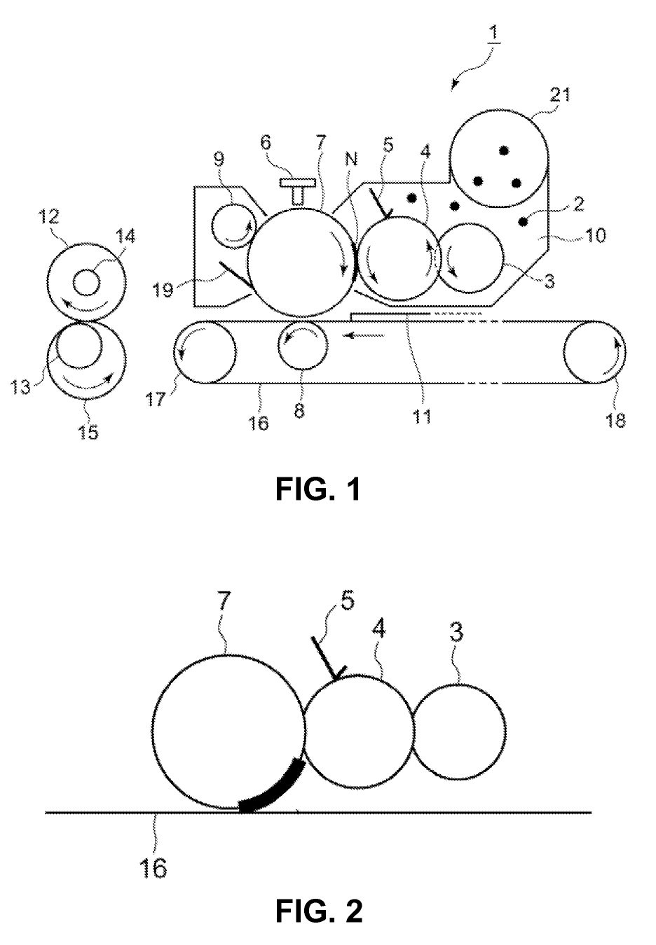

A first embodiment of the present invention will be explained. FIG. 1 is a schematic view showing an image forming apparatus 1 according to the first embodiment of the present invention.

As shown in FIG. 1, the image forming apparatus 1 includes a developing section and a transfer section. In the developing section, there are provided a developing roller 4 as a developer supporting member; a supplying roller 3 as a developer supplying member; a developing blade 5 as a thin layer forming member; a photosensitive drum 7 as an image supporting member; an LED (Light Emitting Diode) head 6 for forming a static latent image on the photosensitive drum 7; and a charging roller 9 for charging the photosensitive drum 7.

In the embodiment, in the transfer section, there are provided a transfer roller 8 for transferring toner 2 as developer on the photosensitive drum 7 to a print medium 11; a transfer belt 16; and a cleaning blade 19 for scraping off the toner 2 remaining on the photosensitive drum 7. Note that the developing roller 4 contacts with the photosensitive drum 7; the developing roller 4 contacts with the supplying roller 3; and the developing roller 4 contacts with the developing blade 5

In the embodiment, the image forming apparatus 1 further includes a developing device 10. In the developing device 10, the developing roller 4 is formed of a shaft coated with a semi-conductive silicone rubber having a hardness of 37° to 47°, and a front layer of the semi-conductive silicone rubber is coated with a silane coupling agent. Further, the developing roller 4 has a roller diameter of 17.52 mm at an end portion thereof and 17.62 mm at a middle portion thereof.

In the embodiment, the developing blade 5 has a thickness of 0.10 mm, and a distal end portion thereof is bent by 90 degrees. The supplying roller 3 is formed of a shaft covered with a silicone sponge having a hardness of 43° to 53°. Further, the supplying roller 3 has a roller diameter of 14.40 mm at an end portion thereof and 15.20 mm at a middle portion thereof. The photosensitive drum 7 is formed of a column shape member having a diameter of 30 mm.

In the embodiment, the developing blade 5 is pressed against the developing roller 4 with a linear pressure of 64 gf/cm, so that a nip amount between the developing roller 4 and the photosensitive drum 7 becomes 0.180 mm. The nip amount represents an overlapped length between the developing roller 4 and the photosensitive drum 7 in a bold solid line shown in FIG. 1.

In the embodiment, the image forming apparatus 1 further includes a fixing section on a downstream side of the developing section and the transfer section in a transportation direction of the print medium 11. In the fixing section, there are provided a heat roller 12 having a cylindrical shape formed of an aluminum tube with an elastic surface; a halogen lamp 14 disposed in the heat roller 12 as a heat source; and a backup roller 13 having a cylindrical shape for receiving a drive force from the heat roller 12 to rotate a fixing belt 15. The heat roller 12 is pressed against the backup roller 13 with the fixing belt 15 in between.

In the embodiment, the image forming apparatus 1 further includes gears (not shown) fixed to each of the rollers and the drum for transmitting a drive force thereto. More specifically, the image forming apparatus 1 includes a drum gear fixed to the photosensitive drum 7; a developing gear fixed to the developing roller 4; a sponge gear fixed to the supplying roller 3; a charge gear fixed to the charging roller 9; a transfer gear fixed to the transfer roller 8; a drive gear fixed to a drive roller 17; an idle gear disposed between the developing gear and the sponge gear; and a heat roller gear fixed to the heat roller 12.

In the embodiment, the image forming apparatus 1 further includes a power source (not shown) for applying a bias voltage to each of the rollers in the developing section and the transfer section, the LED (Light Emitting Diode) head 6, and the halogen lamp 14. The power source disposed in the image forming apparatus 1 is a high voltage power source normally used in an image forming apparatus of an electro-photography type, and a control unit (not shown) controls the power source.

An operation of the image forming apparatus 1 in the embodiment will be explained next. In the image forming apparatus 1 shown in FIG. 1, when the control unit sends a print instruction, a motor disposed in a main body of the image forming apparatus 1 starts rotating, so that a drive force is transmitted to the drum gear through several gears disposed in the main body of the image forming apparatus 1, thereby rotating the photosensitive drum 7. When the drive force is transmitted from the drum gear to the developing gear (not shown), the developing roller 4 starts rotating. When the drive force is transmitted from the developing gear to the sponge gear through the idle gear, the supplying roller 3 starts rotating. Further, when the drive force is transmitted from the drum gear to the charge gear, the charging roller 9 starts rotating.

When the drive force of the motor (not shown) disposed in the main body of the image forming apparatus 1 is transmitted to the transfer gear and the drive gear through several gears in a separate system (not shown), the transfer roller 8, the drive roller 17, a follower roller 18, and the transfer belt 16 start rotating. When the drive force of the motor is transmitted to the heat roller gear through several gears in a separate system (not shown), the heat roller 12 starts rotating. Further, the backup roller 13 and the fixing belt 15 follow and rotate not accompanied with the rotation of the heat roller 12. Each of the rollers and the drum rotate in rational directions shown in FIG. 1.

In the embodiment, when the motor starts rotating, the power source (not shown) disposed in the main body of the image forming apparatus 1 applies specific bias voltages to each of the rollers in the developing section and the transfer section and the halogen lamp 14 in the fixing section.

Toner will be explained in more detail next. First, a method of producing toner through polymerization will be explained.

In the embodiment, toner is produced as follows: 77.5 weight parts of styrene as a binder resin; 22.5 weight parts of n-butyl acrylate as a binder resin; 1.5 weight parts of a low molecular weight polyethylene as an offset inhibitor; 1 weight parts of a charging control agent (for example, Aizen Spiron black TRH, a product of HODOGAYA CHEMICAL CO., LTD.); 7 weight parts of carbon black as a colorant (for example, Printex L, a product of Degussa); and 1 weight parts of 2,2′-azobis-isobutylonitirile are mixed and placed in a mixer (for example, Atoriter MA-01SC, a product of Mistui Miike Chemical Machines, Ltd.). Then, the mixture is mixed for 10 minutes at a temperature of 10° C., thereby obtaining a polymerization compound.

In the next step, 8 weight parts of poly acrylic acid and 0.35 weight parts of di-vinyl benzene are dissolved in methanol, and 180 weight parts of the methanol solution is mixed with 600 weight parts of distilled water, thereby obtaining a dispersion solute for polymerization. The polymerization compound is added to the dispersion solute, and is mixed in a mixer (for example, TK homomixer M-type, a product of Tokushukika Co.,), thereby obtaining a dispersion solution.

In the next step, one litter of the dispersion solution is placed in a separable flask, and the dispersion solution is stirred at a rate of 100 rpm for 12 hours at a temperature of 85° C. under a nitrogen gas flow for polymerization. Through the process described above, the polymerization compound is polymerized to form a dispersed material as intermediate particles.

In the next step, in the aqueous suspended solution of the intermediate particles, an aqueous suspended solution A is prepared using an ultrasonic oscillator (US-150, a product of Nippon Seiki Co., Ltd.). The aqueous suspended solution A is formed of 7.5 weight parts of methyl methacrylate; 2.5 weight parts of n-butyl acrylate; 0.5 weight parts of 2,2′-azobis-isobutylonitirile as a polymerization initiator; 0.1 weight parts of sodium lauryl sulfate; and 80 weight parts of water. Then, 4 weight parts of the aqueous suspended solution A is dropped in the aqueous suspended solution of the intermediate particles, so that the intermediate particles are swollen.

Immediately after the aqueous suspended solution A is dropped, the aqueous suspended solution is observed with an optical microscope. According to the observation, no suspension droplet is observed. Accordingly, it is confirmed that the swelling is completed in a very short period of time.

In the next step, the aqueous suspended solution is stirred for 10 hours at a temperature of 85° C. for a second stage polymerization. After the aqueous suspended solution is cooled down, the dispersion solute is dissolved using 0.5 N hydrochloric acid. Then, the dispersed material is filtrated, washed with water, and dried. Further, the dispersed material is dried for ten hours under a reduced pressure of 10 mmHg at a temperature of 10° C. At last, the dispersed material is classified with an air classifier, thereby obtaining base toner as base particles having an average particle size of 7 μm.

In the next step, hydrophobic silica fine particles (for example, RA200HS, a product of NIPPON AEROSIL Co., Ltd.) as an outer additive is added to and mixed with the base toner, thereby obtaining toner.

An experiment was conducted for evaluating the toner thus obtained. In the experiment, various base toners having different charge amounts and toners with an outer additive added thereto were evaluated. In the various base toners having different charge amounts, the charging control agent (Aizen Spiron black TRH) was added at various amounts. The charging control agent has a negative charge property. Accordingly, when an amount of the charging control agent increases, a charge amount of toner negatively charged increases.

In the experiment, an amount of the hydrophobic silica fine particles was adjusted to obtain toners having the various charge amounts after the outer additive was added. The hydrophobic silica fine particles have a positive charge property. Accordingly, when an amount of the hydrophobic silica fine particles increases, a charge amount of toner decreases.

The fine particles added to the base toner include silica, alumina, titanium oxide, barium titanate, magnesium titanate, calcium titanate, strontium titanate, zinc oxide, silica sand, clay, mica, wollastonite, diatomite, chromium oxide, cerium oxide, colcothar, antimony trioxide, magnesium oxide, zirconium oxide, barium sulfate, barium carbonate, calcium carbonate, silicon carbide, silicon nitride, and the likes. In the experiment, silica was used as the fine particles mixed with the base toner.

In the experiment, a blow-off charge amount measurement device such as a particle charge amount measurement device TB-203 (a product of KYOCERA Chemical Corporation) was used for measuring a saturated charge amount Q/M μC/g of toner per one gram thereof as a parameter of charge properties of the base toner and toners.

In measuring the charge amount, 0.3 g of toner and 9.7 g of a carrier F-60 (a product of POWDERTECH Co., Ltd.) were mixed in a plastic container having a capacity of 100 ml. The plastic container containing the carrier and toner was placed in a vibrator device (for example, YS-LD, a product of YAYOI CO., LTD.), and was vibrated at a vibration speed of 200 times/minute for 30 minutes. Immediately after the plastic container was vibrated, 100 mg of the mixture of toner and the carrier was placed in the blow-off charge amount measurement device, thereby measuring the charge amount thereof under conditions such as a blow pressure of 7 kPa, a suction pressure of −4 kPa, a temperature of 23° C., a humidity of 50%, and a suction time of 10 minutes.

Through the process described above, the saturated charge amount Q/M was obtained as a toner charge amount Q0 before the outer additive was added, and the saturated charge amount Q/M was obtained as a toner charge amount Q1 after the outer additive was added. Table shows the toner charge amount Q0 and the toner charge amount Q1 of the toners used in the experiment. Note that the toner charge amount Q1 represented an original state of the toners before a continuous printing operation was conducted.

TABLE

| | Toner charge amount | Toner charge amount |
|---|---|---|
| Toner | Q0 (μC/g) | Q1 (μC/g) |
| No. 1 | −55 | −30 |
| No. 2 | −55 | −35 |
| No. 3 | −55 | −40 |
| No. 4 | −55 | −45 |
| No. 5 | −55 | −50 |
| No. 6 | −70 | −45 |
| No. 7 | −70 | −50 |
| No. 8 | −70 | −55 |
| No. 9 | −70 | −60 |
| No. 10 | −70 | −65 |
| No. 11 | −85 | −60 |
| No. 12 | −85 | −65 |
| No. 13 | −85 | −70 |
| No. 14 | −85 | −75 |
| No. 15 | −85 | −80 |
| No. 16 | −100 | −75 |
| No. 17 | −100 | −80 |
| No. 18 | −100 | −85 |
| No. 19 | −100 | −90 |
| No. 20 | −100 | −95 |

An experiment was conducted for evaluating durability of the toners using the developing device 10 and the image forming apparatus 1 each described above. In the experiment, a text was printed until a rotation number of the developing roller 4 reached 32,000, and a load applied to the toner represented the durability. The load applied to the toner was generated through a pressure due to friction of the toner in the developing device 10 at the contact portions between the developing roller 4 and the photosensitive drum 7, the developing roller 4 and the supplying roller 3, and the developing roller 4 and the developing blade 5.

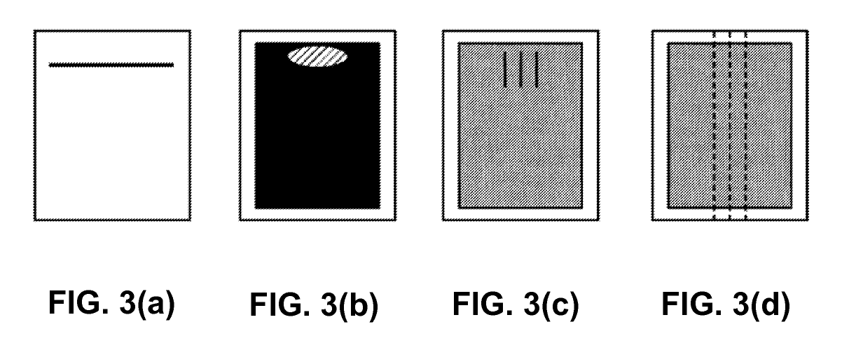

A method of obtaining evaluation data for evaluating the durability of the toner will be explained next. FIGS. 3(a) to 3(d) are schematic views showing samples of printed sheets according to the first embodiment of the present invention. More specifically, FIG. 3(a) is a schematic view showing a printed sheet having a 1.25% lateral band pattern, FIG. 3(b) is a schematic view showing a printed sheet having a solid pattern, FIG. 3(c) is a schematic view showing a printed sheet having a brash stain, and FIG. 3(d) is a schematic view showing a printed sheet having a base stain.

In the method of obtaining the evaluation data, first 200 g of the toner was placed in a toner cartridge 21. Then, the image forming apparatus 1 was placed for more than 12 hours in an environment (NN environment) at a temperature of 22° C. and a humidity of 40%. Afterward, regular data (described later) was obtained as an initial state (initial regular data) before the developing roller 4 rotated.

Immediately after the regular data were obtained, the 1.25% lateral band pattern (described later) was printed on sheets every other page under the NN environment until the rotation number of the developing roller 4 reached 32,000. Immediately after the rotation number of the developing roller 4 reached 32,000, regular data (after the printing operation) were obtained.

The 1.25% lateral band pattern was printed at a sheet transportation speed of 162 mm/sec. As shown in FIG. 3(a), the 1.25% lateral band pattern was printed on an A4 sheet in a 1.25% area thereof, and had a density of 100%. The A4 sheet was a P cardboard A4 (a product of Fuji Xerox Co., Ltd.).

In order to evaluate the durability of the toner, the regular data were obtained in terms of an image density, a fog amount, a stain, and a toner charge amount. Then, the regular data were evaluated as follows.

In order to evaluate the image density, a solid image with a 100% density was printed on an A4 excellent white sheet 70 Kg (a product of Oki Data Corporation), and a reflection density of a density measurement position was measured at an upper center of the sheet after the image was printed. The upper center of the sheet was an arbitrary position in a hatched area shown in FIG. 3(b). The reflection density was measured with X-Rite 528 (a product of X-Rite Corp.) using a filter of a status 1 generally used for a printed sheet. When the image density was more than 1.20, a result was good.

In the embodiment, the fog is a phenomena in which toner is developed in a non-text area of a sheet. When toner has a relatively small absolute value of the charge amount, toner charged with a polarity opposite to normal toner may be generated. When toner charged with the opposite polarity is developed in the non-text area of the sheet, the fog occurs.

FIG. 2 is a schematic view showing the photosensitive drum 7 of the image forming apparatus 1 according to the first embodiment of the present invention. In the experiment, the toner was collected using Mending Tape 810 (a product of Sumitomo 3M Limited) from an area on the photosensitive drum 7 (solid line area in FIG. 2) between the contact point with the developing roller 4 and the contact point with the transfer belt 16. After the toner was collected, Mending Tape 810 was attached to a white sheet, and the fog amount was measured using a color difference meter CM-2600d (a product of Konica Minolta Holdings Inc.). Then, a difference with respect to a tape without the toner was measured at five locations, i.e., end portions, a center portion, and middle portions in between of the photosensitive drum 7, and an average value thereof was calculated as a measurement value. When the measurement value was less than 2.00, a result was good.

In the embodiment, the stain is also a phenomenon in which toner on the developing roller 4 is developed in a non-text area of a sheet. When toner has a relatively large absolute value of the charge amount, a sum of a potential of a surface of the developing roller 4 and a potential of toner on the developing roller 4 may exceed a potential of a surface of the photosensitive drum 7. In this case, toner moves until the potential of the developing roller 4 becomes equal to the potential of the photosensitive drum 7, so that toner is developed in the non-text area of the sheet.

In order to evaluate the stain, a half-tone pattern with a 25% density was printed on the A4 excellent white sheet 70 Kg (a product of Oki Data Corporation), and the pattern thus printed was visually evaluated to confirm abnormalities shown in FIGS. 3(c) and 3(d). In the brash stain shown in FIG. 3(c), vertical lines having a print density greater than that of a surrounding area became visible when the half-tone pattern is printed. In the base stain shown in FIG. 3(d), toner was developed from the developing roller 4 to the photosensitive drum 7 regardless of a print pattern. The brash stain may be less serious than the base stain. When both of the brash stain and the base stain were not visible, a result was good.

In the experiment, the toner charge amount was obtained as a parameter indicating a charge characteristic of the toner after the printing operation. Note that the toner falling from the toner cartridge 21 stayed around the developing roller 4. Toner staying around the developing roller 4 in the developing device 10 after the printing operation was measured, so that the toner charge amount Q/M was obtained as a toner charge amount Q2 after the printing operation. Similar to the toner charge amount Q0 and the toner charge amount Q1, the toner charge amount Q2 was obtained using the blow-off charge amount measurement device.

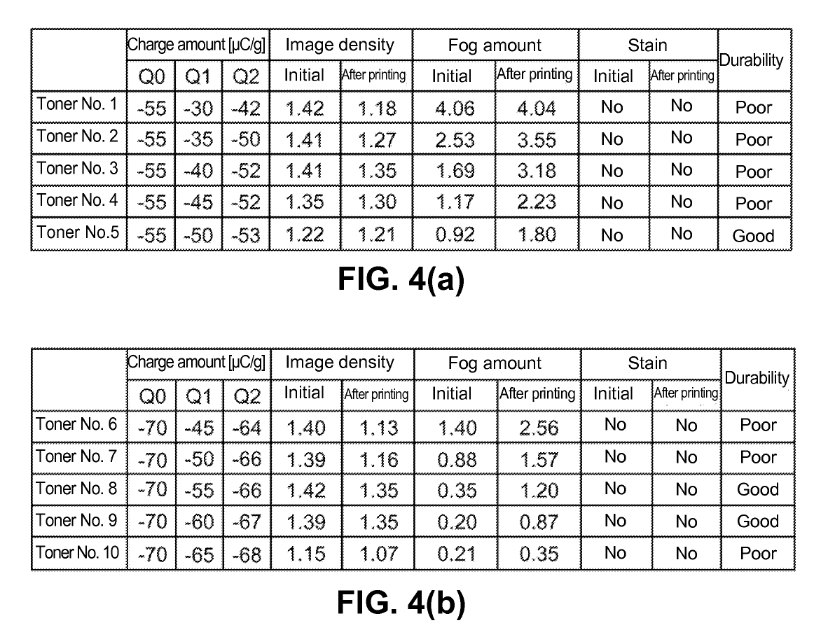

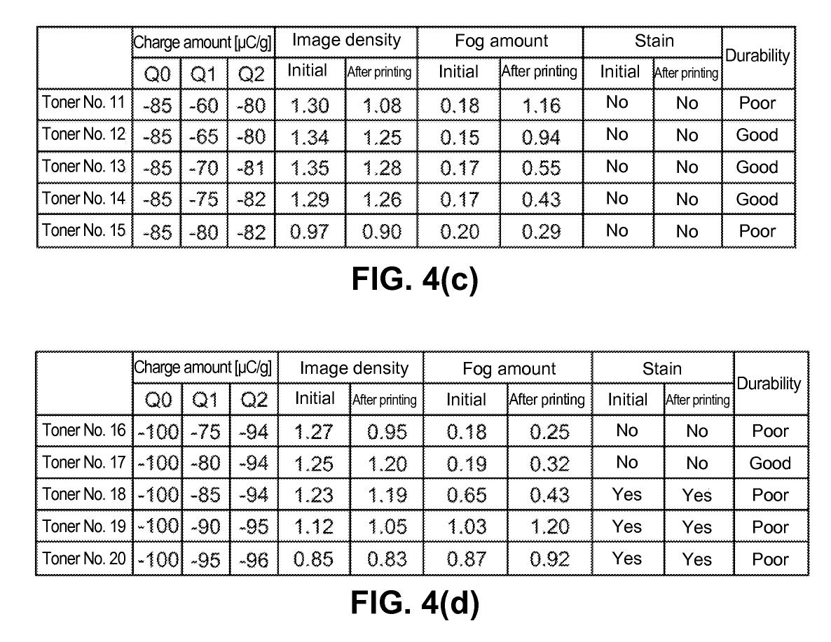

FIGS. 4(a) to 4(d) are tables showing evaluation results No. 1 of toner according to the first embodiment of the present invention. As described above, the toner charge amount Q0 represents the saturated charge amount Q/M of the base toner; the toner charge amount Q1 represents the saturated charge amount Q/M of the toner in the initial state; and the toner charge amount Q2 represents the charge amount Q of the toner after the printing operation.

More specifically, FIG. 4(a) is a table showing evaluation results of the durability of toner using the base toner having the toner charge amount Q0 of 55 μC/g. FIG. 4(b) is a table showing evaluation results of the durability of toner using the base toner having the toner charge amount Q0 of 70 μC/g. FIG. 4(a) is a table showing evaluation results of the durability of toner using the base toner having the toner charge amount Q0 of 85 μC/g. FIG. 4(a) is a table showing evaluation results of the durability of toner using the base toner having the toner charge amount Q0 of 100 μC/g. In FIGS. 4(a) to 4(d), when the regular data of the image density, the fog amount, and the stain showed good in the initial state and after the printing operation, the durability was good.

As shown in FIGS. 4(a) to 4(d), when the absolute value of the toner charge amount Q1 was less than 45, the fog amount in the initial state tended to become worse due to an insufficient charge amount of the toner. Further, when the absolute value of the toner charge amount Q1 was greater than 85, the stain became visible in the initial state and after the printing operation due to an excessive charge amount of the toner.

Further, when a difference between the toner charge amount Q0 and the toner charge amount Q1 (Q0−Q1) became large, the image density decreased to a larger extent. This is because silica came off toner and was attached to the developing roller 4, so that the toner was not easily attached to the developing roller 4.

Further, when a difference between the toner charge amount Q0 and the toner charge amount Q1 (Q0−Q1) was small, the image density in the initial state and after the printing operation became small. This is because only a small amount of silica was added to the toner and flow ability of the toner lowered, so that a sufficient amount of the toner was not supplied to the developing roller 4. The flow ability of the toner indicates how easy the toner moves. When the flow ability of the toner is low, the supplying roller 3 does not supply a sufficient amount of the toner, thereby lowering the image density.

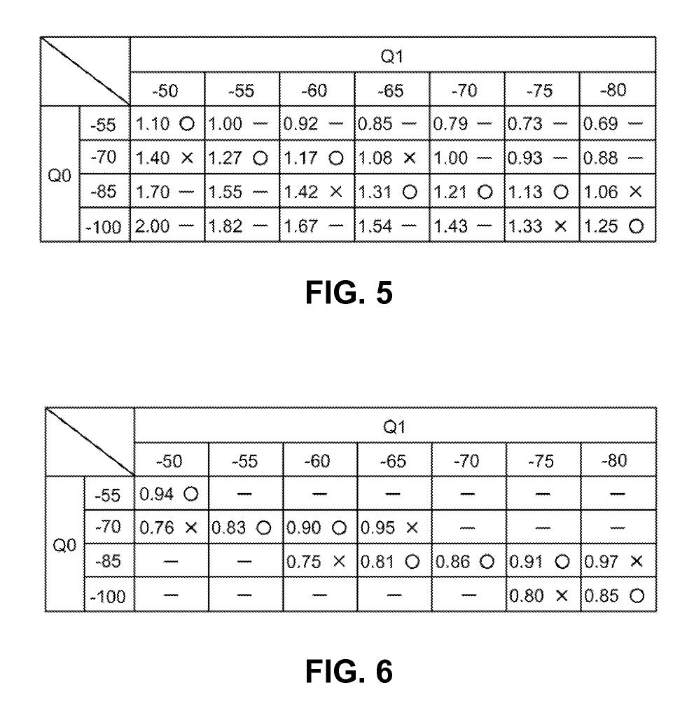

FIG. 5 is a table showing evaluation results No. 2 of toner according to the first embodiment of the present invention. More specifically, the table shows a relationship between the toner charge amounts Q0 and Q1 and a ratio of the toner charge amounts Q0 and Q1 (Q0/Q1). In the table, the toner charge amount Q0 is arranged in columns and the toner charge amount Q1 is arranged in rows. The ratio of the toner charge amounts Q0 and Q1 (Q0/Q1) and the durability evaluation results are shown in each of cells.

As shown in FIG. 5, for example, when toner had the toner charge amount Q0 of −55 and the toner charge amount Q1 of −50, i.e., the toner No. 5, the durability evaluation result was good, and the ratio of the toner charge amounts Q0 and Q1 was 1.10 (Q0/Q1=−55/−50=1.10). In the table, ◯ represents a good result; x represents a poor result; and - represents no result. When the absolute value of the toner charge amount Q1 was smaller than 45 or greater than 85, only poor results were observed, and the results are omitted from the table.

From the durability evaluation results shown in FIG. 5, when the toner charge amount Q1 is within a range between −50 and −80 and the ratio of the toner charge amounts Q0 and Q1 (Q0/Q1) is within a range between 1.10 and 1.31, it is possible to obtain toner having good durability.

FIG. 6 is a table showing evaluation results No. 3 of toner according to the first embodiment of the present invention. More specifically, the table shows a relationship between the toner charge amounts Q0 and Q1 and a ratio of the toner charge amounts Q1 and Q2 (Q1/Q2). As described above, the toner had the toner charge amount Q1 in the initial state before the continuous printing operation was performed. Further, the toner had the toner charge amount Q2 after the continuous printing operation, i.e., the continuous 32,000 rotations, was performed.

In the table, the toner charge amount Q0 is arranged in columns and the toner charge amount Q1 is arranged in rows. The ratio of the toner charge amounts Q1 and Q2 (Q1/Q2, before the continuous printing operation/after the continuous printing operation) and the durability evaluation results are shown in each of cells. Similar to the table shown in FIG. 5, in the table, ◯ represents a good result; x represents a poor result; and - represents no result.

As shown in FIG. 6, for example, when the toner had the toner charge amount Q0 of −55 and the toner charge amount Q1 of −50, i.e., toner No. 5, the durability evaluation result was good, and the ratio of the toner charge amounts Q1 and Q2 is 0.94 (Q1/Q1=−50/−53=0.94). When the absolute value of the toner charge amount Q1 was smaller than 45 or greater than 85, only poor results were observed, and the results are omitted from the table.

From the durability evaluation results shown in FIG. 6, when the toner charge amount Q1 is within a range between −50 and −80 and the ratio of the toner charge amounts Q1 and Q2 (Q1/Q2) is within a range between 0.81 and 0.94, it is possible to obtain toner having good durability.

From the evaluation results shown in FIGS. 4 to 6, when the toner charge amount Q1 is within a range between −50 μC/g and −80 μC/g and the ratio of the toner charge amounts Q0 and Q1 (Q0/Q1) is within a range between 1.10 and 1.31, or the toner charge amount Q1 is within a range between −50 μC/g and −80 μC/g and the ratio of the toner charge amounts Q1 and Q2 (Q1/Q2) is within a range between 0.81 and 0.94, it is possible to print an image with good quality without the stain, the fog, and the abnormality of the lowered image density due to the continuous printing operation.

In a conventional image forming apparatus, there tend to have problems such as a stained text, a fog text, a lowered image density, and the likes. In other word, when the conventional image forming apparatus prints on a large number of sheets in the continuous printing operation, image quality tends to lower. Accordingly, when toner has a saturated charge amount less than a specific level, it is difficult to obtain good image quality.

As described above, in the embodiment, it is possible to prevent problems such as a stained text, a fog text, a lowered image density, and the likes even when a large number of sheets are printed. Accordingly, it is possible to provide the image forming apparatus capable of maintaining good image quality.

### Second Embodiment

A second embodiment of the present invention will be explained next. In the first embodiment, the toner No. 10 or the toner No. 15 showed the abnormality of the lowered image density as shown in FIG. 4. It is considered that, in the toner No. 10 or the toner No. 15, an insufficient amount of silica was added to the base toner, thereby lowering the flow ability. Accordingly, an insufficient amount of toner was supplied to the developing roller 4, thereby lowering the image density.

In the second embodiment, in addition to silica, titanium oxide is added as an outer additive. Titanium oxide is formed in fine particles having a weak negative charge property. When titanium oxide and silica are added to the base toner, an amount of the outer additive increases, thereby improving the flow ability.

In the second embodiment, toner is produced with a method through polymerization similar to that in the first embodiment. More specifically, similar to the first embodiment, the hydrophobic silica fine particles and 0.7 weight parts of titanium oxide are added to the base toner as the base particles. Then, similar to the first embodiment, the mixture is processed to obtain toner.

In the second embodiment, similar to the first embodiment, an experiment was conducted for evaluating the toner. In the experiment, various toners having different charge amounts adjusted through changing an amount of the hydrophobic silica fine particles were evaluated.

Table shows the toner charge amount Q0 and the toner charge amount Q1 of toner used in the experiment.

TABLE

| | Toner charge amount | Toner charge amount |
|---|---|---|
| Toner | Q0 (μC/g) | Q1 (μC/g) |
| No. 21 | −70 | −65 |
| No. 22 | −95 | −80 |

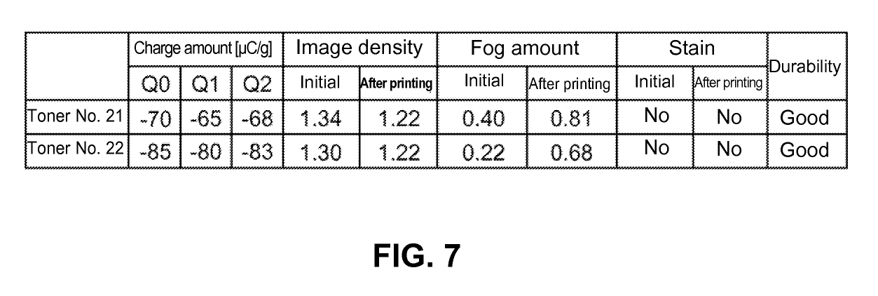

In the second embodiment, similar to the first embodiment, the toner No. 21 and the toner No. 22 were evaluated with respect to the durability. FIG. 7 is a table showing evaluation results No. 1 of toner according to the second embodiment of the present invention. The evaluation was conducted using the same device with the same method as those in the first embodiment, and the results are shown in the same way as that in the first embodiment.

As described above, in the first embodiment, an insufficient amount of the outer additive is added to the base toner, thereby lowering the flow ability. Accordingly, an insufficient amount of toner is supplied to the developing roller 4, thereby lowering the image density.

In the second embodiment, on the other hand, as shown in FIG. 7, the image density in the initial state did not show any problem. Accordingly, it is confirmed that when titanium oxide is added, it is possible to prevent the image density in the initial state from lowering due to low flow ability.

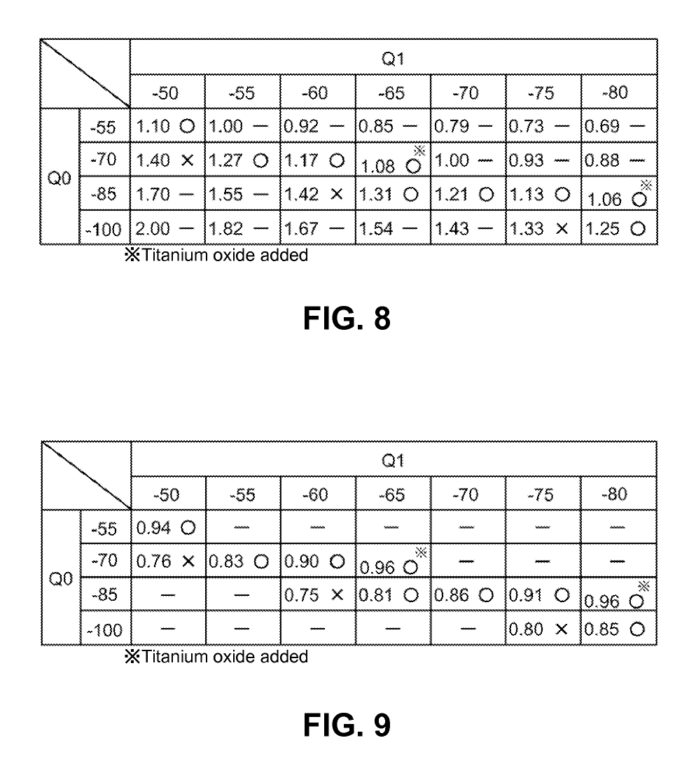

FIG. 8 is a table showing evaluation results No. 2 of toner according to the second embodiment of the present invention. More specifically, the table shows a relationship between the toner charge amounts Q0 and Q1 and a ratio of the toner charge amounts Q0 and Q1 (Q0/Q1). In the table, similar to FIG. 5, the toner charge amount Q0 is arranged in columns and the toner charge amount Q1 is arranged in rows. The ratio of the toner charge amounts Q0 and Q1 (Q0/Q1) and the durability evaluation results are shown in each of cells. In the table, ◯ represents a good result; x represents a poor result; and - represents no result. Note that the cells with the asterisk are the toner No. 21 and the toner No. 22 with titanium oxide added thereto, i.e., (Q0, Q1)=(−70, −65), (Q0, Q1)=(−85, −80).

As shown in FIG. 8, for example, when the toner had the toner charge amount Q0 of −70 and the toner charge amount Q1 of −65, i.e., toner No. 21, the durability evaluation result was good, and the ratio of the toner charge amounts Q0 and Q1 is 1.08 (Q0/Q1=−70/−65=1.08).

From the durability evaluation results shown in FIG. 8, when the toner charge amount Q1 is within a range between −65 and −80 and the ratio of the toner charge amounts Q0 and Q1 (Q0/Q1) is within a range between 1.06 and 1.08, it is possible to obtain toner having good durability.

FIG. 9 is a table showing evaluation results No. 3 of toner according to the second embodiment of the present invention. More specifically, the table shows a relationship between the toner charge amounts Q0 and Q1 and a ratio of the toner charge amounts Q1 and Q2 (Q1/Q2). As described above, the toner had the toner charge amount Q1 in the initial state before the continuous printing operation was performed. Further, the toner had the toner charge amount Q2 after the continuous printing operation, i.e., the continuous 32,000 rotations, was performed.

In the table, similar to FIG. 6, the toner charge amount Q0 is arranged in columns and the toner charge amount Q1 is arranged in rows. The ratio of the toner charge amounts Q1 and Q2 (Q1/Q2, before the continuous printing operation/after the continuous printing operation) and the durability evaluation results are shown in each of cells. Similar to the table shown in FIG. 5, in the table, ◯ represents a good result; x represents a poor result; and - represents no result.

As shown in FIG. 9, for example, when the toner had the toner charge amount Q0 of −85 and the toner charge amount Q1 of −80, i.e., the toner No. 22, the durability evaluation result is good, and the ratio of the toner charge amounts Q1 and Q2 is 0.96 (Q1/Q1=−80/−83=0.94).

From the durability evaluation results shown in FIG. 9, when the toner charge amount Q1 is within a range between −65 and −80 and the ratio of the toner charge amounts Q1 and Q2 (Q1/Q2) is about 0.96, it is possible to obtain toner having good durability.

As described above, in the second embodiment, when titanium oxide is added to the base toner, it is possible to prevent the flow ability from lowering due to an insufficient amount of the outer additive when only silica is added. Accordingly, it is possible to perform the printing operation with a proper charge amount.

In the case that silica and titanium oxide are added to the base toner, when the toner charge amount Q1 is within a range between −65 and −80 and the ratio of the toner charge amounts Q0 and Q1 (Q0/Q1) is within the range between 1.06 and 1.08, or the ratio of the toner charge amounts Q1 and Q2 (Q1/Q2) is about 0.96, it is possible to prevent the image density from lowering due to low flow ability in the continuous printing operation. Further, it is possible to print an image with good quality and durability without the stain, the fog, and the abnormality of decreasing in the image density.

In the embodiments described above, the present invention is applied to the image forming apparatus 1, and may be applicable to a copier, a facsimile, an a multifunction product that develops an image using toner The disclosure of Japanese Patent Application No. 2008-227859, filed on Sep. 5, 2008, is incorporated in the application.

While the invention has been explained with reference to the specific embodiments of the invention, the explanation is illustrative and the invention is limited only by the appended claims.

What is claimed is:

1. Developer to be used in an image forming apparatus of an electro-photography type, in which a developer supporting member attaches the developer to a static latent image supporting member for developing a static latent image, comprising:
an outer additive; and
base particles,
wherein said developer has a charge amount Q1 before the image forming apparatus performs a continuous printing operation and a charge amount Q2 after the image forming apparatus performs the continuous printing operation so that a ratio of Q1 to Q2 (Q1/Q2) becomes between 0.81 and 0.94.

2. The developer according to claim 1, wherein said developer has the charge amount Q1 in a range between −50 μC/g and −80 μC/g.

3. The developer according to claim 1, wherein said outer additive includes silica.

4. The developer according to claim 1, wherein said developer has the charge amount Q2 after the image forming apparatus performs the continuous printing operation in which the image forming apparatus prints a text having an image density of 100% in an area of 1.25% relative to a printable area.

5. The developer according to claim 1, wherein said developer has the charge amount Q2 after the image forming apparatus performs the continuous printing operation in which the developer supporting member rotates 32,000 times.

6. The developer according to claim 1, wherein said base particles has a charge amount Q0 before the outer additive is added to the base particles so that a ratio of Q0 to Q1 (Q0/Q1) becomes between 1.10 and 1.31.

7. Developer to be used in an image forming apparatus of an electro-photography type, in which a developer supporting member attaches the developer to a static latent image supporting member for developing a static latent image, comprising:
an outer additive; and
base particles having a charge amount Q0 before the outer additive is added thereto,
wherein said developer has a charge amount Q1 after the outer additive is added to the base particles so that a ratio of Q0 to Q1 (Q0/Q1) becomes between 1.06 and 1.08.

8. The developer according to claim 7, wherein said developer has the charge amount Q1 in a range between −65 μC/g and −80 μC/g.

9. The developer according to claim 7, wherein said outer additive includes silica and titanium oxide.

10. The developer according to claim 7, wherein said developer has a charge amount Q2 after the image forming apparatus performs a continuous printing operation so that a ratio of Q1 to Q2 (Q1/Q2) becomes substantially 0.96.

11. The image forming apparatus including the developer supporting member for supporting the developer according to claim 1.
